(19) United States
(12) Patent Application Publication
(10) Pub. No.: US 2018/0295572 A1
(43) Pub. Date: Oct. 11, 2018

(54) WIRELESS LOCAL AREA NETWORK (WLAN) SELECTION FOR LONG TERM EVOLUTION (LTE) - WLAN AGGREGATION (LWA)

(71) Applicant: QUALCOMM Incorporated, San Diego, CA (US)

(72) Inventors: Kaushik BHATTACHARYA, Hyderabad (IN); Saurabh PATEL, Hyderabad (IN); Asimava BERA, Hyderabad (IN); Nilotpal DHAR, Hyderabad (IN); Uday Kumar CHIDURALA, Karimnagar (IN)

(21) Appl. No.: 15/482,145

(22) Filed: Apr. 7, 2017

(51) Int. Cl. H04W 48/20; H04B 17/318; H04W 8/22; H04W 28/18

(52) U.S. Cl. CPC H04W 48/20; H04B 17/318; H04W 84/12; H04W 28/18; H04W 8/22

(57) ABSTRACT

Methods and apparatus for selection of a Wireless Local Area Network (WLAN) Access Point (AP) for Long Term Evolution (LTE)-WLAN aggregation (LWA) is provided. A Station (STA) receives information from at least one WLAN AP of a plurality of WLAN APs in the STA's vicinity, the information being indicative of a capability of the at least one WLAN AP to support LWA. The STA selects one of the plurality of WLAN APs for connection with the STA in LWA configuration, based at least on the received information.

### FIELD

The present disclosure relates generally to wireless communication, and more particularly, to methods and apparatus for selecting Wireless Local Area Network (WLAN) Access Point (AP) for Long Term Evolution (LTE)-WLAN aggregation (LWA).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE/LTE-Advanced is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

Certain aspects of the present disclosure provide a method for wireless communications by a User Equipment (UE). The method generally includes receiving information from at least one Wireless Local Area Network (WLAN) Access Point (AP) of a plurality of WLAN APs in the STA's vicinity, regarding a capability of the at least one WLAN AP to support LTE (Long Tem Evolution)-WiFi aggregation (LWA), and selecting one of the plurality of WLAN APs for connection with the STA in LWA configuration, based at least on the received information regarding the capability of the at least one WLAN AP to support LWA.

Certain aspects of the present disclosure provide an apparatus for wireless communication by a user equipment (UE). The apparatus generally includes means for receiving information from at least one Wireless Local Area Network (WLAN) Access Point (AP) of a plurality of WLAN APs in the STA's vicinity, regarding a capability of the at least one WLAN AP to support LTE (Long Tem Evolution)-WiFi aggregation (LWA), and means for selecting one of the plurality of WLAN APs for connection with the STA in LWA configuration, based at least on the received information regarding the capability of the at least one WLAN AP to support LWA.

Certain aspects of the present disclosure provide an apparatus for wireless communication by a user equipment (UE). The apparatus generally includes at least one processor and a memory coupled to the at least one processor. The at least one processor is generally configured to receive information from at least one Wireless Local Area Network (WLAN) Access Point (AP) of a plurality of WLAN APs in the STA's vicinity, regarding a capability of the at least one WLAN AP to support LTE (Long Tem Evolution)-WiFi aggregation (LWA), and select one of the plurality of WLAN APs for connection with the STA in LWA configuration, based at least on the received information regarding the capability of the at least one WLAN AP to support LWA.

Certain aspects of the present disclosure provide a computer-readable medium storing instructions which when executed by at least one processor performs a method for wireless communication by a Station (STA), the method generally including receiving information from at least one Wireless Local Area Network (WLAN) Access Point (AP) of a plurality of WLAN APs in the STA's vicinity, regarding a capability of the at least one WLAN AP to support LTE (Long Tem Evolution)-WiFi aggregation (LWA), and selecting one of the plurality of WLAN APs for connection with the STA in LWA configuration, based at least on the received information regarding the capability of the at least one WLAN AP to support LWA.

Aspects generally include methods, apparatus, systems, computer program products, computer-readable medium, and processing systems, as substantially described herein with reference to and as illustrated by the accompanying drawings. “LTE” refers generally to LTE, LTE-Advanced (LTE-A), LTE in an unlicensed spectrum (LTE-whitespace), etc.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control plane.

FIG. 6 is a diagram illustrating an example of an evolved Node B and user equipment in an access network, in accordance with certain aspects of the disclosure.

FIG. 7 illustrates a system diagram of a typical wireless network supporting LWA in accordance with certain aspects of the present disclosure.

FIG. 8 illustrates example LTE aggregation with carrier Wi-Fi, in accordance with certain aspects of the present disclosure.

FIG. 9 illustrates example operations that may be performed by an STA (e.g., UE) to select a WLAN AP to participate in LWA operation, in accordance with certain aspects of the present disclosure.

### DETAILED DESCRIPTION

LTE-WLAN aggregation (LWA) provides data aggregation at the radio access network where an eNB schedules packets to be served on LTE and WiFi radio links. The advantage of this solution is that it may provide better control and utilization of resources on both links. This can increase the aggregate throughput for all users and improve the total system capacity by better managing the radio resources among users. However, issues remain as to how to efficiently implement LWA. For example, efficient WLAN selection is a problem. Certain aspects of the present disclosure discuss a more efficient implementation of LWA by efficient WLAN AP selection for LWA operation.

For example, one or more WLAN APs in the vicinity of a User Equipment (UE) may transmit information regarding their capabilities to support LWA operation. A UE may receive the information regarding the WLAN APs' LWA capabilities and use the received information to select an AP to participate in LWA operation.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software, or combinations thereof whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

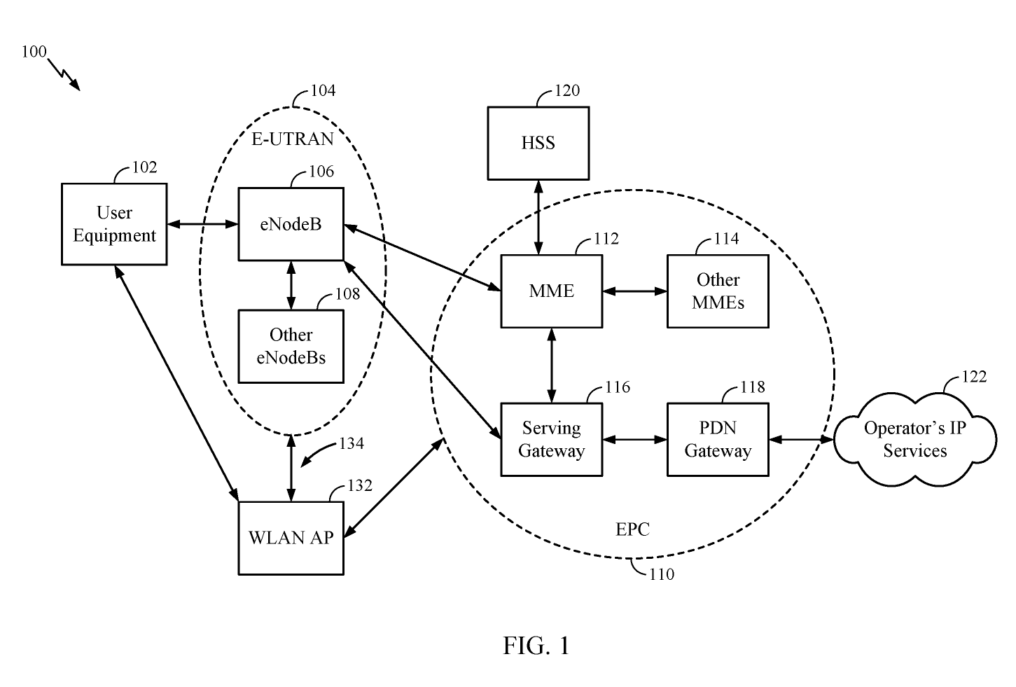

FIG. 1 is a diagram illustrating an network architecture 100 in which aspects of the present disclosure may be practiced.

In an aspect, a station (STA) (e.g., UE 102) receives information from at least one Wireless Local Area Network (WLAN) Access Point (AP) (e.g., 132) of a plurality of WLAN APs in the STA's vicinity, regarding a capability of the at least one WLAN AP to support LTE-WiFi aggregation (LWA). The STA selects one of the plurality of WLAN APs for connection with the STA in LWA configuration, based on the received information regarding the capability of the at least one WLAN AP to support LWA.

The network architecture 100 may include one or more user equipment (UE) 102, an LTE Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. Exemplary other access networks may include an IP Multimedia Subsystem (IMS) PDN, Internet PDN, Administrative PDN (e.g., Provisioning PDN), carrier-specific PDN, operator-specific PDN, and/or GPS PDN. As shown, the EPS provides packet-switched services, however, as those skilled in the art will readily appreciate, the various concepts presented throughout this disclosure may be extended to networks providing circuit-switched services.

The LTE E-UTRAN includes the evolved Node B (eNB) 106 and other eNBs 108. The eNB 106 provides user and control plane protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), an access point, or some other suitable terminology. The eNB 106 may provide an access to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a netbook, a smart book, an ultrabook, a drone, a robot, a sensor, a monitor, a meter, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include, for example, the Internet, the Intranet, an IP Multimedia Subsystem (IMS), and a PS (packet-switched) Streaming Service (PSS). In this manner, the UE 102 may be coupled to the PDN through the LTE network.

The network architecture 100 may further include one or more Wireless Local Area Network (WLAN) Access Points (APs) (e.g., WLAN AP 132). The UE 102 may support dual connectivity to the LTE and WLAN Radio Access Technologies (RATs). The UE 102 may be LWA capable and may be connected to the EPC 110 via the eNB (e.g, eNBs 106, 108) and the WLAN AP 132, and may aggregate data in LWA configuration to achieve higher data rates and load balancing between the two RATs. As shown each of the eNBs 106 and 108 and may be connected to the WLAN AP 132 via a backhaul link 134. An eNB 106 or 108 and the WLAN AP 132 may exchange control information and traffic over the backhaul link 134 to implement and maintain the LWA operation. For example, information may be exchanged by the eNB 106 or 108 and WLAN AP 132 to split data traffic between the two paths (e.g., UE-eNB and UE-AP paths) to increase the aggregate data rate and further for load balancing purpose. For example, the UE 102 in LWA configuration may access IP services 122 via the eNB 106 and the WLAN AP 132 simultaneously or concurrently.

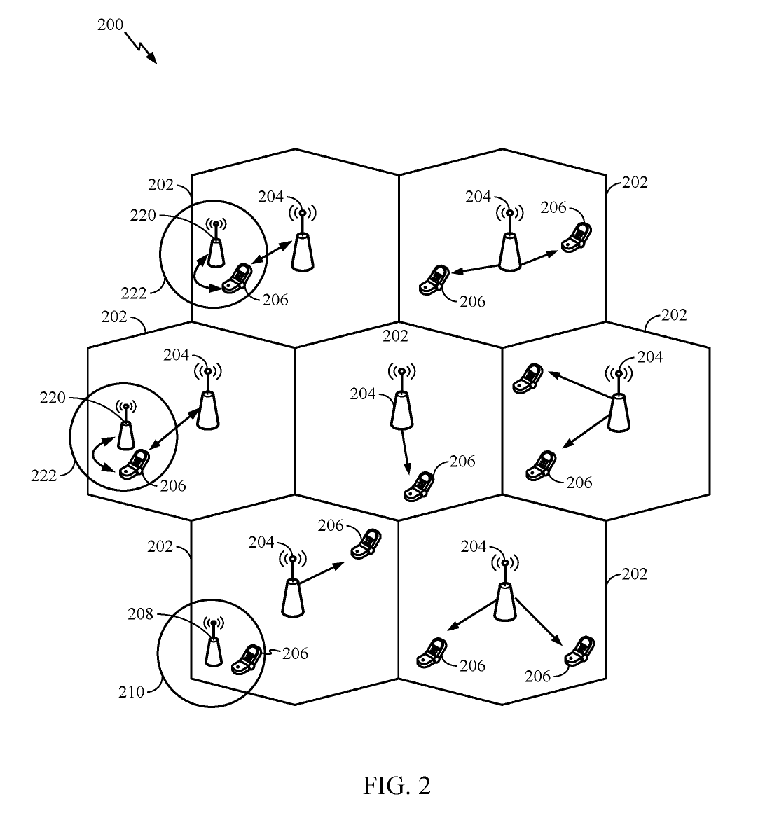

FIG. 2 is a diagram illustrating an example of an access network 200 in an LTE network architecture in which aspects of the present disclosure may be practiced. For example, UEs 206 may be configured to implement techniques for efficiently selecting a WLAN AP for LWA operation in accordance with certain aspects of the present disclosure.

In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. The network 200 may also include one or more relays (not shown). According to one application, a UE may serve as a relay.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

The access network 200 may further include WLAN APs 220 with corresponding WLAN coverage 222 overlapping with eNB cell coverage 202. A UE 206 that is in an overlapping coverage region of the LTE and WLAN networks and that is LWA capable may connect to an LTE eNB 204 and WLAN AP 220 in LWA configuration to achieve higher data rates and load balancing between the two RATs. Further, the WLAN AP 220 and eNB 204 may be connected via a backhaul link to exchange information and traffic to implement and maintain an LWA operation with the UE 206. For example, information may be exchanged by the eNB 204 or 108 and WLAN AP 220 to split data traffic between the two paths (e.g., UE-eNB and UE-AP paths) to increase the aggregate data rate and further for load balancing purpose.

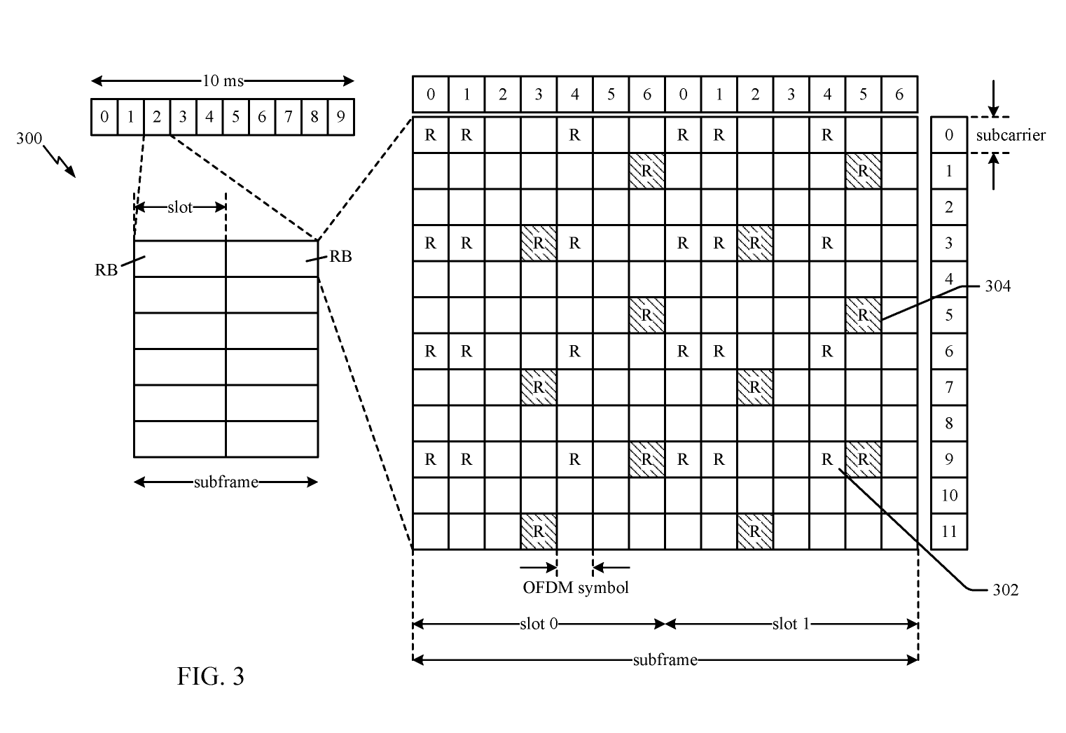

FIG. 3 is a diagram 300 illustrating an example of a DL frame structure in LTE. A frame (10 ms) may be divided into 10 equally sized sub-frames with indices of 0 through 9. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, R 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH. In aspects of the present methods and apparatus, a subframe may include more than one PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

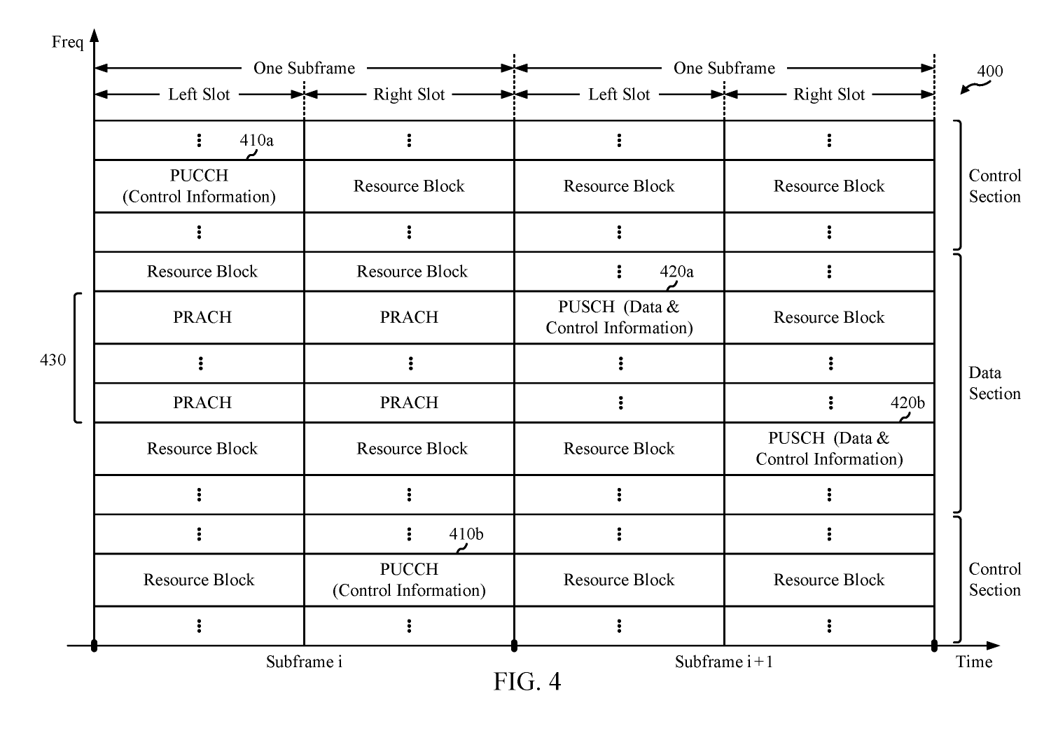

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

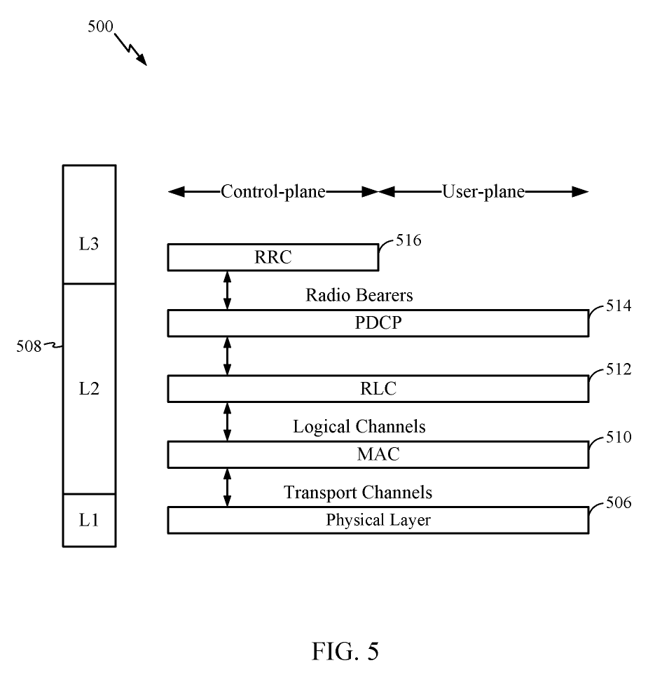

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

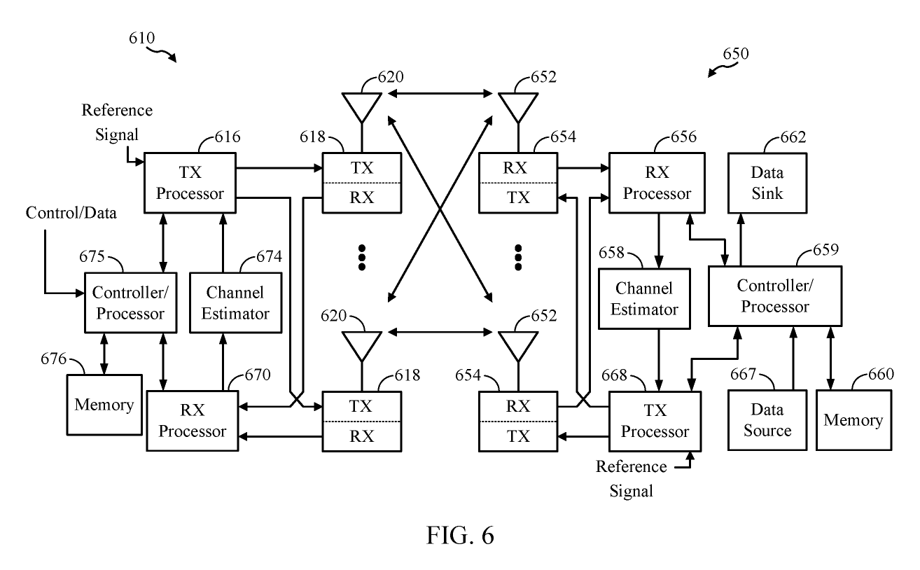

FIG. 6 is a block diagram of an eNB 610 in communication with a UE 650 in an access network, in which aspects of the present disclosure may be practiced.

In an aspect, a station (STA) (e.g., UE 650) receives information from at least one Wireless Local Area Network (WLAN) Access Point (AP) (not shown in FIG. 6) of a plurality of WLAN APs in the STA's vicinity, regarding a capability of the at least one WLAN AP to support LTE-WiFi aggregation (LWA). The STA selects one of the plurality of WLAN APs for connection with the STA in LWA configuration, based on the received information regarding the capability of the at least one WLAN AP to support LWA.

It may be noted that the UE noted above for implementing efficient WLAN AP selection for LWA in accordance with certain aspects of the present disclosure may be implemented by a combination of one or more of the controller 659, the RX processor 656 and/or receiver 654 at the UE 650, for example.

In the DL, at eNB 610, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, at the UE 650, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations. The controllers/processors 675, 659 may direct the operations at the eNB 610 and the UE 650, respectively.

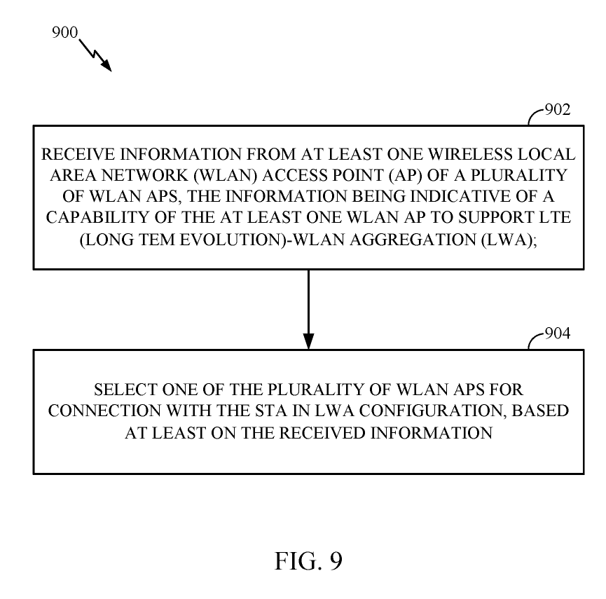

The controller/processor 659 and/or other processors, components and/or modules at the UE 650 may perform or direct operations, for example, operations 900 in FIG. 9, and/or other processes for the techniques described herein for improving inter-RAT measurements. In certain aspects, one or more of any of the components shown in FIG. 6 may be employed to perform example operations 900 and/or other processes for the techniques described herein. The memories 660 and 676 may store data and program codes for the UE 650 and eNB 610 respectively, accessible and executable by one or more other components of the UE 650 and the eNB 610.

### Example Techniques for Efficient Selection of WLAN AP for LWA

An LTE system offers high peak data rates, low latency, improved system capacity, and low operating costs resulting from simplified network architecture. However, the continuously rising demand for data traffic requires further enhancements to the current LTE technology. Internetworking between the LTE network and the unlicensed spectrum WLAN provides additional bandwidth to the operators. The LTE-WLAN aggregation (LWA) provides data aggregation at the radio access network where an eNB schedules packets to be served on LTE and WLAN radio links. The advantage of this solution is that it may provide better control and utilization of resources on both links. This can increase the aggregate throughput for all users and improve the total system capacity by better managing the radio resources among users. LWA is a tight integration at radio level, which allows for real-time channel and load aware radio resource management across WLAN and LTE to provide significant capacity and QoE (Quality of Experience) improvements.

In an LWA system, a UE is connected to the core network via two paths, an eNB operating in a regular licensed spectrum used for LTE network (or other cellular standards) and a WLAN AP managed by the LTE network in an unlicensed spectrum. Generally, an eNB and a WLAN AP are connected by means of a backhaul, which helps in splitting the data packets across the two paths to increase the aggregate data rate.

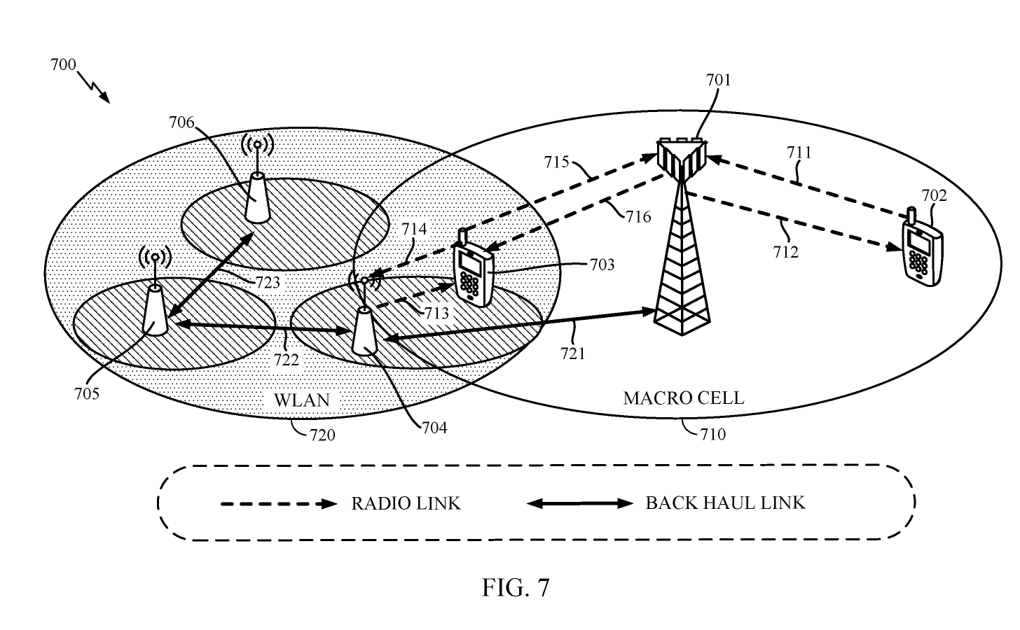

FIG. 7 illustrates a system diagram of a typical wireless network 700 supporting LWA in accordance with certain aspects of the present disclosure. Wireless network 700 is configured with a Macro Cell 710, which includes the anchor macro eNB 701, and a WLAN 720, which includes WLAN APs 704, 705 and 706. Wireless network 700 may be an inter-RAT carrier aggregation (CA) network, with the anchor eNB 701 employing LTE or other cellular standards, while WLAN APs 704, 705 and 706 using WLAN technology, such as Wi-Fi. As shown, wireless network 700 also includes UEs 702 and 703 that support dual connectivity (e.g., support LTE and WLAN connectivity). Wireless network 700 supports multiple component carriers over different frequency channels, dual connectivity, and carrier aggregation for serving cells originated from different eNBs. UE 702 is served by eNB 701 of macro cell 710 with an uplink 711 and down link 712. UE 702 is served by macro cell 710 only because eNB 701 is the only base station in range of the UE 702. UE 703, however, is in the range of both eNB 701 and WLAN AP 704. When UE 703 is configured with dual connectivity, UE 703 is served by eNB 701 with uplink 715 and downlink 716. At the same time, UE 703 is also served by WLAN AP 704 with uplink 714 and downlink 713. UE 703 is configured to be LWA-enabled and may perform data aggregation between its anchor eNB 701 and WLAN AP 704, which is in the range of UE 703.

In one exemplary configuration, initially, UE 703 camps on the macro cell 710 served by anchor eNB 701 and establishes a Radio Resource Control (RRC) connection with the Radio Access Network (RAN). The eNB 701 provides and controls the initial RRC connection and provides NAS mobility information and security input. UE 701 subsequently moves within the coverage area of anchor eNB 701 into a portion of the coverage area of WLAN 720 that overlaps with the coverage area of eNB 701. Upon entering the overlapping coverage area of WLAN 720, UE 701 may select a WLAN AP in its vicinity to aggregate its data traffic with the WLAN if needed. For example, the UE may select the WLAN AP 704 and use additional resources provided by the WLAN AP 704 for LWA operation.

In certain aspects, a selected WLAN AP in LWA configuration with the anchor eNB 701 is connected to the eNB 701 via a backhaul connection. For example, backhaul connection 721 connects macro cell eNB 701 with WLAN AP 704 through Xn interface, for example, Xw or X2 interface. The coordination between anchor eNB 701 and WLAN AP 704 may be performed through Xn interface, for example, Xw or X2 interface. The Xn interfaces, also known as backhaul connections provide communication and coordination between eNBs and WLAN APs. Similarly, backhaul connections 722 and 723 within the WLAN 720 connects WLAN APs 704, 705, and 706 through Xn interface.

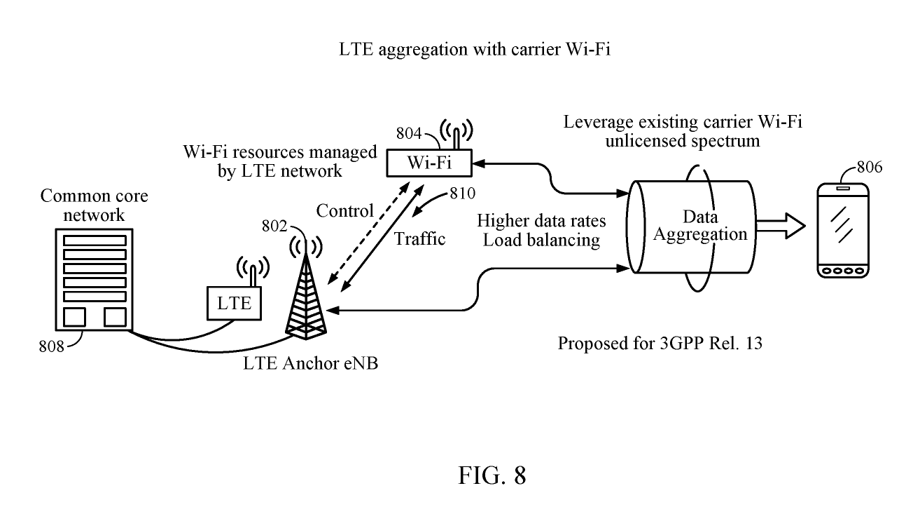

FIG. 8 illustrates example LTE aggregation with carrier Wi-Fi, in accordance with certain aspects of the present disclosure. UE 806 supports dual connectivity to LTE and WLAN Radio Access Technologies (RATs). As shown, the UE 806 is connected to the common core network 808 via LTE anchor eNB 802 and WLAN AP 804, and leverages the existing carrier Wi-Fi to aggregate data in LWA configuration to achieve higher data rates and load balancing between the two RATs. As shown, the anchor eNB 802 is connected to the WLAN AP 804 via a backhaul link 810. The anchor eNB 802 and the WLAN AP 804 exchange control information and traffic over the backhaul link to implement and maintain the LWA operation. For example, information may be exchanged by the eNB 802 and WLAN AP 804 to split data traffic between the two paths (e.g., UE-eNB and UE-AP paths) to increase the aggregate data rate and further for load balancing purpose.

The RAN level aggregation in LWA systems has several advantages including power savings at the Wide Area Network (WAN) end, reduced call setup time at the WAN end, throughput improvement, and avoiding unnecessary tune away and tune in of RF between SIMs of multi SIM phones.

However, issues remain as to how to efficiently implement LWA. For example, efficient WLAN selection is a problem. There may be many WLAN APs deployed in an area. Some of the WLAN APs may not be known to the anchor eNB. Further, some of the APs may not support the LWA feature. In certain aspects, when aUE is selecting a WLAN AP from a plurality of WLAN APs, an LWA capable WLAN AP may be given additional weightage or priority for selection over WLAN APs that do not support LWA, depending on the need of the system, to take advantage of the additional gain that may be provided by an LWA capable WLAN AP operating in an LWA configuration.

Certain systems do not consider the capability of a WLAN AP to support LWA at all when selecting a WLAN AP to connect to a UE. Thus, these systems are often unable to gain from the advantages provided by LWA capable WLAN APs. For example, by not being aware of LWA capabilities of available WLAN APs a UE may connect to a WLAN AP without LWA capability even when other WLAN APs with LWA capability and acceptable link qualities are also available.

In certain aspects, the eNB may transmit a list of WLAN APs in the vicinity of aUE that are LWA capable and that may be selected by the UE to participate in LWA operation. However, this involves a lot of overhead messaging over the RAN interface. For example, the eNB may send a measurement configuration to the UE instructing the UE to measure one or more WLAN APs (e.g. received signal strength measurements). The UE may need to measure one or more of the indicated WLAN APs based on the received measurement configuration and send a measurement report back to the eNB. The eNB, based on the measurement report, may select a particular WLAN AP and signal the UE to attempt establishing a connection with the selected WLAN AP. Additionally, the eNB may transmit a WLAN information request to the UE, and the UE may transmit a WLAN information response back to the eNB including information regarding status of a current WLAN connection with the UE. Thus, this WLAN AP selection procedure may not be efficient, for example, as a result of excessive overhead messaging.

Accordingly, certain aspects of the present disclosure discuss a more efficient implementation of LWA by efficient WLAN AP selection for LWA operation.

For example, in certain aspects, one or more WLAN APs in the vicinity of a UE may transmit information regarding their capabilities to support LWA operation. A UE may receive and use this information regarding the WLAN APs' LWA capabilities to select a WLAN AP to participate in LWA operation. In certain aspects, the WLAN APs transmitting information regarding their LWA capabilities as compared to the LTE network transmitting the LWA capabilities of the WLAN APs significantly reduces messaging overhead, for example between the UE and the LTE network, for selection of an LWA capable WLAN AP by the UE, leading to a more efficient AP selection procedure.

FIG. 9 illustrates example operations 900 that may be performed by an STA (e.g., UE) to select a WLAN AP to participate in LWA operation, in accordance with certain aspects of the present disclosure. In some instances, the STA may correspond to a user equipment 102, 206, 650, 703, or 806, described above with respect to FIGS. 1, 2, 6, 7, and 8 respectively. Operations 900 begin, at 902, by receiving information from at least one WLAN AP of a plurality of WLAN APs (e.g., in the STA's vicinity), the information being indicative of a capability of the at least one WLAN AP to support LWA operation. At 904, the STA selects one of the plurality of WLAN APs for connection with the STA in LWA configuration, based at least on the received information.

In certain aspects, an LWA capable WLAN AP may add a vendor specific IE (Information Element) in its beacon signal, to let UEs in its vicinity know that it is an LWA capable WLAN AP. In certain aspects, this IE may also include indication of a list of operators (e.g., T-Mobile, Verizon etc.) which support the LWA capable WLAN AP (e.g., share the LWA capable WLAN AP).

A UE may select one of a plurality of available WLAN APs in its vicinity for connection with the UE, based at least on information received from one or more of the WLAN APs regarding their corresponding LWA capabilities and optionally based on information regarding operators that support each LWA capable AP.

Generally, a UE selects a WLAN AP based on RSSI (Received Signal Strength Indicator) values measured at the UE for one or more WLAN APs. In certain aspects, a UE, when selecting a WLAN AP (e.g., LWA capable UE), in addition to using RSSI values of one or more WLAN APs, may also receive and use information regarding LWA capabilities of the WLAN APs. For example, a UE while selecting a WLAN AP, when transitioning from an un-connected state to a connected state or while roaming from a first WLAN AP (LWA capable or not) to another WLAN AP, in addition to using RSSI values of one or more available WLAN APs, also takes the information regarding LWA capabilities of the available WLAN APs into account. For example, each of the available WLAN APs may be scored for selection by the UE based on one or more parameters such as a RSSI of a signal (e.g., beacon) received by the UE from the WLAN AP and whether the AP is LWA capable. For example, each of the available APs may be scored based on weighted values for the one or more parameters. In certain aspects, different parameters may be given different weightings and a higher total weightage of the parameters is assigned a higher score. In an aspect, the weighting value of each parameter is a configurable value. In certain aspects, an AP that is LWA capable may have its total weightage increased by a particular weightage value corresponding to having LWA capability. The UE may then select the highest scored AP for connection.

In an aspect, the one or more parameters may include one or more of LWA capability, total throughput (e.g., as result of data aggregation), link quality with the WLAN AP, reliability of the connection etc. In an aspect, the available WLAN APs may be scored based on weights assigned to a combination of parameters (e.g., pre-configured combination) and the highest scored WLAN AP (e.g., having the highest total weightage value) may be selected. As noted above, additional weightage (e.g., configurable additional weightage) may be assigned for LWA capable APs for having LWA capability leading to a higher score for the LWA capable WLAN AP. In an aspect, the combination of parameters used for scoring the WLAN APs may be different based on a type of connection the UE desires. For example, different combinations of the parameters may be chosen for maximizing throughput or for maximizing reliability.

In an aspect, the UE may give higher weightage to LWA capability as compared to the RSSI, and may select an LWA capable WLAN AP with a lower RSSI as compared to other available WLAN APs with higher RSSI but that are not LWA capable. In an aspect, if multiple LWA capable WLAN APs are available, the UE may score an LWA capable AP with higher RSSI higher than other LWA capable APs.

In an aspect, the UE may select an LWA capable WLAN AP if the received signal strength of the LWA capable WLAN AP is above a certain configuration signal quality threshold.

In an aspect, in addition to considering information received from WLAN APs regarding their LWA capabilities for AP selection, the UE considers information regarding which operator(s) support LWA on a particular WLAN AP. For example, the UE may not select a WLAN AP if one or more operators supported by the UE do not support the WLAN AP. In an aspect, the UE designates a WLAN AP as not supporting LWA if the list of operators received from the AP does not include an operator the UE is connected to.

In certain aspects, when the UE is in a connected state (e.g., already connected to a WLAN AP), in addition to considering information received from WLAN APs regarding their LWA capabilities for AP selection, one or more actions may be taken to avoid the UE from missing beacons from other WLAN APs (e.g., other than the connected WLAN AP) that may carry information regarding their LWA capability. For example, one or more OFF channel activities may be scheduled to not coincide with receiving beacons from the WLAN APs.

Generally, OFF channel activity is any activity for which devices in a WLAN (e.g., WLAN AP, UE) have to change channels for operation. Generally, there are multiple channels available for a connection between a UE and a WLAN AP. A channel which a WLAN AP and aUE are currently connected with is referred to as a home channel. The UE either periodically or in response to certain events (e.g., the user moving away from the WLAN AP) may change channels, for example, to maintain a good quality of service. For example, if the user is moving away from a WLAN AP that it is currently connected, the link quality with the WLAN AP may go down. In this case, the UE may search and select another WLAN AP operating on a different channel to maintain signal quality. This generally involves the UE switching to different channels and scanning for other WLAN APs in its vicinity on the different channels. The UE may miss beacons transmitted from WLAN capable APs when it is scanning on other channels.

In certain aspects, the OFF channel scheduler may be adjusted to schedule one or more OFF channel activities to not coincide with beacon receive timings of WLAN APs.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

Moreover, the term “or” is intended to mean an inclusive “or” rather than an exclusive “or.” That is, unless specified otherwise, or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. A phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for wireless communication by a wireless station (STA), comprising:
receiving information from at least one Wireless Local Area Network (WLAN) Access Point (AP) of a plurality of WLAN APs, the information being indicative of a capability of the at least one WLAN AP to support LTE (Long Tem Evolution)-WLAN aggregation (LWA); and
selecting one of the plurality of WLAN APs for connection with the STA in LWA configuration, based at least on the received information.

2. The method of claim 1, wherein selecting one of the plurality of WLAN APs is further based on at least one received signal strength measured at the STA for the at least one WLAN AP.

3. The method of claim 1, wherein selecting one of the plurality of WLAN APs comprises:
selecting the one of the plurality of WLAN APs for the connection with the STA if the information indicates that the one of the plurality of WLAN APs supports LWA and if the received signal strength of the one of the plurality of WLAN APs measured at the STA exceeds a configurable signal quality threshold.

4. The method of claim 1, wherein the information comprises an indication of a list of operators supporting the at least one WLAN AP.

5. The method of claim 4, wherein selecting one of the plurality of WLAN APs comprises designating the at least one WLAN AP as not supporting LWA if the list of operators does not include an operator the STA is connected to.

6. The method of claim 1, further comprising scheduling at least one OFF channel activity to not coincide with the receiving the information from the at least one WLAN AP.

7. The method of claim 1, wherein receiving the information comprises receiving the information as an information element (IE) in a beacon from the at least one WLAN AP.

8. An apparatus for wireless communication by a Station (STA), comprising:
means for receiving information from at least one Wireless Local Area Network (WLAN) Access Point (AP) of a plurality of WLAN APs, the information being indicative of a capability of the at least one WLAN AP to support LTE (Long Tem Evolution)-WLAN aggregation (LWA); and
means for selecting one of the plurality of WLAN APs for connection with the STA in LWA configuration, based at least on the received information.

9. The apparatus of claim 8, wherein the means for selecting one of the plurality of WLAN APs is configured to select the one of the plurality of WLAN APs further based on at least one received signal strength measured at the STA for the at least one WLAN AP.

10. The apparatus of claim 8, wherein the means for selecting one of the plurality of WLAN APs is configured to:
select the one of the plurality of WLAN APs for the connection with the STA if the information indicates that the one of the plurality of WLAN APs supports LWA and if the received signal strength of the one of the plurality of WLAN APs measured at the STA exceeds a configurable signal quality threshold.

11. The apparatus of claim 8, wherein the information comprises an indication of a list of operators supporting the at least one WLAN AP.

12. The apparatus of claim 11, wherein the means for selecting one of the plurality of WLAN APs is configured to designate the at least one WLAN AP as not supporting LWA if the list of operators does not include an operator the STA is connected to.

13. The apparatus of claim 8, further comprising means for scheduling at least one OFF channel activity to not coincide with the receiving the information from the at least one WLAN AP.

14. The apparatus of claim 8, wherein the means for receiving the information is configured to receive the information as an information element (IE) in a beacon from the at least one WLAN AP.

15. An apparatus for wireless communication by a Station (STA), comprising:
at least one processor configured to:
receive information from at least one Wireless Local Area Network (WLAN) Access Point (AP) of a plurality of WLAN APs, the information being indicative of a capability of the at least one WLAN AP to support LTE (Long Tem Evolution)-WLAN aggregation (LWA); and
select one of the plurality of WLAN APs for connection with the STA in LWA configuration, based at least on the received information; and
a memory coupled to the at least one processor.

16. The apparatus of claim 15, wherein the at least one processor is configured to select one of the plurality of WLAN APs further based on at least one received signal strength measured at the STA for the at least one WLAN AP.

17. The apparatus of claim 15, wherein the at least one processor is configured to select one of the plurality of WLAN APs by:
selecting the one of the plurality of WLAN APs for the connection with the STA if the information indicates that the one of the plurality of WLAN APs supports LWA and if the received signal strength of the one of the plurality of WLAN APs measured at the STA exceeds a configurable signal quality threshold.

18. The apparatus of claim 15, wherein the information comprises an indication of a list of operators supporting the at least one WLAN AP.

19. The apparatus of claim 18, wherein the at least one processor is configured to select one of the plurality of WLAN APs comprises designating the at least one WLAN AP as not supporting LWA if the list of operators does not include an operator the STA is connected to.

20. The apparatus of claim 15, wherein the at least one processor is further configured to schedule at least one OFF channel activity to not coincide with the receiving the information from the at least one WLAN AP.

21. The apparatus of claim 15, wherein the at least one processor is configured to receive the information by receiving the information as an information element (IE) in a beacon from the at least one WLAN AP.

22. A computer-readable medium storing instructions for wireless communication by a Station (STA), the instructions, when executed by at least one processor, perform:
receiving information from at least one Wireless Local Area Network (WLAN) Access Point (AP) of a plurality of WLAN APs, the information being indicative of a capability of the at least one WLAN AP to support LTE (Long Tem Evolution)-WLAN aggregation (LWA); and
selecting one of the plurality of WLAN APs for connection with the STA in LWA configuration, based at least on the received information

23. The computer-readable medium of claim 22, wherein selecting one of the plurality of WLAN APs is further based on at least one received signal strength measured at the STA for the at least one WLAN AP.

24. The computer-readable medium of claim 22, wherein selecting one of the plurality of WLAN APs comprises:
selecting the one of the plurality of WLAN APs for the connection with the STA if the information indicates that the one of the plurality of WLAN APs supports LWA and if the received signal strength of the one of the plurality of WLAN APs measured at the STA exceeds a configurable signal quality threshold.

25. The computer-readable medium of claim 22, wherein the information comprises an indication of a list of operators supporting the at least one WLAN AP.

26. The computer-readable medium of claim 25, wherein selecting one of the plurality of WLAN APs comprises designating the at least one WLAN AP as not supporting LWA if the list of operators does not include an operator the STA is connected to.

27. The computer-readable medium of claim 22, further comprising instructions for scheduling at least one OFF channel activity to not coincide with the receiving the information from the at least one WLAN AP.

28. The computer-readable medium of claim 22, wherein receiving the information comprises receiving the information as an information element (IE) in a beacon from the at least one WLAN AP.
